(19) United States
(12) Patent Application Publication
(10) Pub. No.: US 2024/0359245 A1
(43) Pub. Date: Oct. 31, 2024

(54) CALIBRATION OF A SOLDERING MACHINE

(71) Applicant: Illinois Tool Works Inc., Glenview, IL (US)

(72) Inventors: Antonie Cornelis COLIJN, Nieuwendijk (NL); Gerardus Johannes Adrianus Maria DIEPSTRATEN, Dongen (NL)

(21) Appl. No.: 18/685,781

(22) PCT Filed: Aug. 25, 2022
(86) PCT No.: PCT/US2022/041441

§ 371 Date: Feb. 22, 2024

(30) Foreign Application Priority Data
Aug. 26, 2021 (EP) 21193290.0

(51) Int. Cl. B23K 1/08; B23K 3/08; B23K 31/02

(52) U.S. Cl. CPC B23K 1/085; B23K 3/08; B23K 31/02

(57) ABSTRACT

An example method of calibrating the operation of soldering apparatus for use in a soldering machine, in which the soldering apparatus includes at least one nozzle which is configured to apply solder to an electronics board, in use, involves: providing machine settings to the soldering apparatus, the machine settings including a nozzle target calibration position and at least one solder setting for the at least one nozzle; positioning the at least one nozzle according to the nozzle target calibration position; pumping solder from the at least one nozzle according to the at least one solder setting, when the at least one nozzle is positioned according to the target calibration position; obtaining at least one image of the soldering apparatus when the at least one nozzle is positioned according to the nozzle target calibration position; determining, from the at least one image, at least one nozzle characteristic; and adjusting the machine settings to reduce a difference between the at least one nozzle characteristic determined from the at least one image, and a corresponding expected at least one nozzle characteristic.

### TECHNICAL FIELD OF INVENTION

The invention relates to calibrating soldering apparatus for use in a soldering machine. In particular, the invention relates to calibrating the application of solder to an electronics board in a soldering machine.

### BACKGROUND

Selective soldering machines are used to solder electronic components to boards, such as to printed circuit boards (PCBs). The boards pass through the machine and undergo a soldering process to connect the components to the board. The soldering process typically includes the application of flux to the joints between the components and the board, preheating the components and the board, and applying solder to the connections between the components and the board.

Solder may be applied to the board using a select wave solder pot. The solder pot has at least one nozzle, and molten solder is pumped in an upward direction through an aperture in the end of the nozzle(s). The nozzle may be a non-wettable nozzle, wherein ejected solder accumulates at the tip of the nozzle(s) to be applied to the electronics board. The nozzle(s) may be a wettable nozzle, in which pumping the solder forms a solder wave which flows out of the aperture and back down to a reservoir. The electronics board is contacted to the solder wave to apply solder thereto.

The solder pot may be a selective wave solder pot, wherein the board is conveyed to a position over the solder pot and the solder pot moves in the plane of the board (in the X & Y directions), to be positioned underneath the part of the board to be soldered. Typically, the solder pot can also be moved towards and away from the board (in the Z direction), if required, to optimise the required height of the solder wave.

Alternatively, the solder pot may be a multi-wave solder pot, wherein multiple solder nozzles are located in the solder pot, the layout of the nozzles corresponding to the layout of the components to be soldered to the board. The ejected solder from each nozzle applies solder to the board, and often the solder pot can be moved in the Z direction to optimise wave height. In multi-wave soldering, the solder pot and/or the board can often be adjusted in the X and Y directions, to ensure that the nozzles correspond to the correct solder locations.

Clearly, with either type of solder pot, if the board and solder pot are in incorrect X and Y positions relative to one another then solder will be applied to incorrect locations on the board. This could mean that electrical components are not secured to the board or that bridging occurs between components on the board. Furthermore, if the distance between the solder pot and any part of the board is different to that which is stored in a controller for the machine, then the wave height of the solder may be inappropriate for soldering the board.

In order to overcome these problems, the X, Y and Z positions of the solder pot and/or the conveyor may be calibrated. Calibration may include moving the solder pot to a specific location until it is detected by position sensors. Differences between the detected position and the expected position are then corrected in a controller such that subsequent soldering processes are more accurate. However, this calibration method is time consuming, as the solder pot must be moved to a specific calibration location for calibration to take place. This means that the calibration method is performed infrequently, and so inaccuracies in position of the solder pot can increase during production of boards, as, for example, components heat up and so change shape.

Calibration may also include measuring the height of the solder wave and correcting the stored solder wave height based on the measured wave height. The solder wave height may change over time due to, for example, coil temperature changes in the solder pump or a build-up of dross (oxidised solder). Wave height calibration may be performed using a conductive metal needle, wherein the solder wave height is increased until the solder contacts the needle. As with position calibration, this requires the soldering pot to be placed in a specific calibration location and then for the solder wave height to be increased incrementally, which is time consuming. Otherwise, this requires the needle must be moved to the nozzle(s), which is also time consuming. This calibration process is also time consuming if it must be performed for each nozzle in a multi-wave soldering pot. Accordingly, this calibration method is typically performed infrequently. Furthermore, this method does not account for deviation in the distance between nozzles and the board, due to, for example, board warpage. Therefore, even with successful calibration, an incorrect amount of solder may be applied to locations on the boards.

Further to these problems, infrequent calibration may also mean that deterioration of parts of the soldering machine are not identified, because it is not possible to identify trends in measured parameters. Therefore, problems may go undetected for a long time, leading to machine downtime and poor-quality production.

It would therefore be beneficial to overcome at least some of these limitations.

### SUMMARY

According to the present invention, there is provided a method of calibrating the operation of soldering apparatus for use in a soldering machine, the soldering apparatus comprising at least one nozzle which is configured to apply solder to an electronics board, in use, the method comprising:
providing machine settings to the soldering apparatus, the machine settings including a nozzle target calibration position and at least one solder setting, for the at least one nozzle:
positioning the at least one nozzle according to the nozzle target calibration position;
pumping solder from the at least one nozzle according to the at least one solder setting, when the at least one nozzle is positioned according to the nozzle target calibration position;
obtaining at least one image of the soldering apparatus when the at least one nozzle is positioned according to the nozzle target calibration position;
determining, from the at least one image, at least one nozzle characteristic;
adjusting the machine settings to reduce a difference between the at least one nozzle characteristic determined from the at least one image, and a corresponding expected at least one nozzle characteristic.

The soldering apparatus may be in the soldering machine. The machine settings may be provided to the soldering machine. The machine settings may be provided from a memory.

Advantageously, the nozzle target calibration position may be anywhere within the operating range of the nozzle and need not be at discrete location. This decreases the time to perform calibrations and enables calibration to be performed more frequently.

The at least one nozzle characteristic may comprise an actual calibration position, for example in three dimensional Cartesian coordinates, and/or an orientation, of the at least one nozzle.

The at least one image of the soldering apparatus may be obtained while pumping solder from the at least one nozzle.

The at least one nozzle characteristic may comprise any number of:
at least one geometric characteristic of the solder flowing from the at least one nozzle, the at least one geometric characteristic comprising, for example, a height, or a shape, of the flow of solder from the at least one nozzle;
a temperature of the solder flowing from the at least one nozzle.

The machine settings may further comprise a board target calibration position. The soldering apparatus may further comprise a conveyor which positions the board according to the board target calibration position, in use. The at least one nozzle characteristic may comprise a distance between the at least one nozzle and the conveyor.

The method may further comprise positioning the board using the conveyor according to the board target calibration position, wherein the board target calibration position is expected to position the board relative to the at least one nozzle such that the at least one nozzle is adjacent a soldering or calibration location on the board.

The method may further comprise determining at least one board characteristic from the at least one image.

The method may further comprise adjusting the machine settings to reduce a difference between the at least one board characteristic determined from the at least one image, and a corresponding expected at least one board characteristic.

The board may be a calibration board or an electronics board.

Advantageously, images of every board can be obtained, or images can be obtained of a lot of boards in the production line, and so machine settings can be adjusted regularly.

The at least one board characteristic may comprise any number of:
an actual calibration position of the board, for example in three dimensional Cartesian coordinates;
a location of each soldering or calibration location on the board;
a distance between the at least one nozzle and the corresponding solder or calibration location on the board;
a temperature of the board.

An identity of the board may be determined from the image, for example using fiducial marks on the board.

Advantageously, machine settings can be used which are specific to the board.

The at least one image may be obtained using at least one camera, for example a thermal imaging camera. The camera may record a plurality of images over a time period.

Advantageously, the at least one nozzle characteristic and/or the at least one board characteristic may be obtained without the necessity for contact with the soldering apparatus or board, or any other part of the soldering machine. Further advantageously, multiple images can be obtained by the at least one camera, and so the at least one nozzle characteristic and/or the at least one board characteristic can be obtained during soldering of the board. Further advantageously, by recording a plurality of images over a time period the stability of the solder wave, from taking multiple measurements and thereby calculating variation, can be obtained. If the shape of the solder wave is not stable then this can be used to indicate that cleaning is required, or other maintenance actions are required, for example topping up of the solder level.

The method may further comprise measuring oxygen levels in the solder wave. The method may further comprise adjusting a nitrogen supply to the at least one nozzle to adjust the oxygen level in the solder wave. The nitrogen supply may be controlled by the machine settings.

According to another aspect of the invention there is provided a method of maintaining a soldering machine, the method comprising recording and analysing any number of the aforementioned machine settings, nozzle characteristics, board characteristics and adjustments to the machine settings. These may be used to identify requirements for repair, maintenance, or replacement of parts of the soldering machine.

Advantageously, the aforementioned recording and analysis may be used to identify trends in performance of the soldering machine, which may be indicative of faults, or a need for maintenance.

According to another aspect of the invention there is provided soldering calibration apparatus comprising:
soldering apparatus for use in a soldering machine, the soldering apparatus comprising at least one adjustable nozzle which is configured to apply solder to an electronics board, in use, and at least one pump configured to pump solder from the at least one adjustable nozzle;
at least one camera configured to obtain at least one image of the soldering apparatus;
a controller configured to:
   provide machine settings to the soldering apparatus, the machine settings including a nozzle target calibration position and at least one solder setting for the at least one nozzle:
   position the at least one nozzle according to the nozzle target calibration position;
   pump solder from the at least one nozzle according to the at least one solder setting, when the at least one nozzle is positioned according to the target calibration position;
   obtain, using the at least one camera, at least one image of the soldering apparatus when the at least one nozzle is positioned according to the nozzle target calibration position;
   determine, from the at least one image, at least one nozzle characteristic;
   adjust the machine settings to reduce a difference between the at least one nozzle characteristic determined from the at least one image, and a corresponding expected at least one nozzle characteristic.

The soldering calibration apparatus may be for use in the soldering machine.

The soldering calibration apparatus may comprise a memory for storing the machine settings. The soldering calibration apparatus may comprise a memory in which the machine settings are stored.

The at least one nozzle characteristic may comprise an actual calibration position, for example in three dimensional Cartesian coordinates, and/or an orientation, of the at least one nozzle.

The at least one image of the soldering apparatus may be obtained while pumping solder from the at least one nozzle.

The at least one nozzle characteristic may comprise any number of:
at least one geometric characteristic of the solder flowing from the at least one nozzle, the at least one geometric characteristic comprising, for example, a height, or a shape, of the flow of solder from the at least one nozzle;
a temperature of the solder flowing from the at least one nozzle.

The soldering apparatus may further comprise a conveyor which positions the board according to the board target calibration position, in use. The machine settings may further comprise a board target calibration position. The at least one nozzle characteristic may comprise a distance between the at least one nozzle and the conveyor.

The machine settings may further comprise a board target calibration position.

The controller may be further configured to position the board using the conveyor according to the board target calibration position, wherein the board target calibration position is expected to position the board relative to the at least one nozzle such that the at least one nozzle is adjacent a soldering or calibration location on the board.

The controller may be further configured to determine at least one board characteristic from the at least one image.

The controller may be further configured to adjust the machine settings to reduce a difference between the at least one board characteristic determined from the at least one image, and a corresponding expected at least one board characteristic.

The at least one board characteristic may comprise any number of:
an actual calibration position of the board, for example in three dimensional Cartesian coordinates;
a location of each soldering or calibration location on the board;
a distance between the at least one nozzle and the corresponding solder or calibration location on the board;
a temperature of the board.

An identity of the board may be determined from the image. An identity of the board may be determined using fiducial marks on the board.

The at least one camera may comprise a thermal imaging camera.

The soldering calibration apparatus may further comprise an oxygen sensor configured to measure an oxygen level around the at least one nozzle. The controller may be further configured to adjust a nitrogen supply to the at least one nozzle to adjust the oxygen level.

According to another aspect of the invention there is provided a soldering machine comprising the aforementioned soldering calibration apparatus.

### BRIEF DESCRIPTION OF DRAWINGS

Example embodiment(s) of the invention are illustrated in the accompanying drawings, in which:

FIG. 1 illustrates soldering apparatus according to a first embodiment;

FIG. 2 illustrates the soldering apparatus of FIG. 1;

FIG. 3 illustrates a conveyor as using in the soldering apparatus of FIG. 1, the conveyor for moving a board; and

FIG. 4 illustrates soldering apparatus according to a second embodiment.

### DESCRIPTION

The illustrative embodiment relates to a method calibrating the operation of soldering apparatus in a soldering machine.

The method is intended for use in a selective soldering machine. However, the method can be used with any soldering machine.

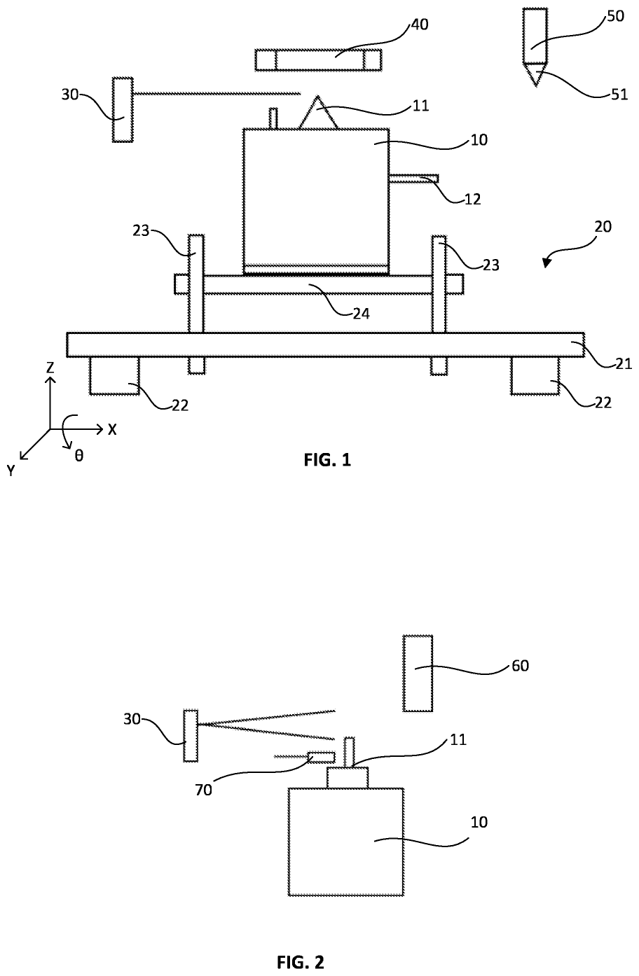

Referring to FIG. 1, there is shown an example of soldering apparatus, which may be a part of soldering calibration apparatus, and which has a select wave solder pot 10. The solder pot 10 has a nozzle 11. The nozzle 11 may be a non-wettable nozzle or a wettable nozzle. The operating parameters of the nozzle 11 are adjustable. If a non-wettable nozzle is used, then, in use, the solder pot 10 ejects molten solder out of an upper aperture of the nozzle 11 such that the molten solder forms an accumulation of solder (not shown) which is suspended at a tip of the nozzle 11. If a wettable nozzle is used, then, in use, molten solder is pumped out of the nozzle 11 to form a solder wave with a continuous flow, such that solder flows back into a reservoir located in the soldering pot 10. Each soldering location on an electronics board may contact the ejected solder in turn such that solder is applied to the soldering location. The molten solder is pumped from the solder pot 10 using a magnetic pump (not shown), in this example.

The solder pot 10 has a temperature sensor 12 which measures the temperature of the molten solder. The temperature sensor 12 is in communication with a controller. The solder pot 10 has a pump temperature sensor (not shown) which measures the temperature of a coil of the magnetic pump. The pump temperature sensor is in communication with the controller. Solder wire is provided to the solder pot 10 from a reel (not shown). The feed speed of the solder wire is controlled by controlling a rotation speed of the reel using a motor (not shown). An encoder (not shown) measures the rotation, or the rotation speed, of the reel. The motor and the encoder are in communication with the controller.

The soldering apparatus has a movement system 20. The movement system 20 has X-direction translation means 21, Y-direction translation means 22, and Z-direction translation means 23, the X, Y and Z directions being Cartesian directions as shown by the arrows in FIG. 1. The movement system 20 also has θ-direction rotation means 24, to rotate the solder pot 10 about the X-direction. The movement system 20 may also have rotation means for rotating the solder pot 10 about the Y-direction and/or Z-directions.

In this example, the solder pot 10 is mounted to the e-direction rotation means 24. The θ-direction rotation means 24 is mounted to the Z-direction translation means 23. The Z-direction translation means 23 is mounted to the X-direction translation means 21. The X-direction translation means 21 is mounted to the Y-direction translation means 22. In this way, the nozzle 10 may be moved to any X, Y or Z position within movement bounds of the movement system 20 and rotated about the X-direction to change the direction with which solder is ejected from the nozzle 11.

In this example, the soldering apparatus, or the soldering calibration apparatus, includes a camera 30. In this example, the camera 30 is positioned to view the ejected solder along the X-direction, but it will be appreciated that the camera 30 may view the ejected solder from any suitable position and direction. It will also be appreciated that any number of cameras 30 is envisaged, wherein each camera may view the ejected solder from a different direction.

In this example there is provided a laser fork sensor 40. The laser fork sensor 40 has a laser beam, and the laser fork sensor 40 provides a signal when the laser beam is broken.

In this example there is provided a contacting needle, or pin, sensor 50. The needle sensor 50 has a conducting tip 51 which points in a generally opposite direction to the flow of solder from the nozzle 11. The needle sensor 50 provides a signal when the conductive tip 51 is contacted by solder.

The operation of the soldering apparatus may be calibrated by using machine settings which are provided to the soldering apparatus. The machine settings are stored in a memory (not shown). The memory may be a part of the soldering apparatus, the soldering calibration apparatus, or may be an external memory. The machine settings include a nozzle target calibration position for the nozzle 11. The nozzle 11 is positioned, using the movement system 20, according to the nozzle target calibration position. The nozzle 11 may be positioned anywhere within movement bounds of the movement system 20, may be adjacent to either of the laser fork sensor 40 or needle sensor 50, if present, or may be in the field of view of the camera 30.

In this example, the machine settings also include solder settings. The solder pot 10 heats and melts the solder wire which is provided from the solder wire reel, according to the solder settings. The magnetic pump pumps molten solder out of the solder pot 10 according to the solder settings. The machine settings also include solder reel settings. The rate at which soldering wire is provided to the solder pot 10, as controlled by the motor attached to the reel, is controlled according to the solder reel settings. The rate at which soldering wire is unwound from the reel is measured using the encoder. The motor and the encoder thereby define a closed loop system. The pump rate is influenced by the solder temperatures, as measured by the temperature sensor 12, and the coil temperature of the pump, as measured by the pump temperature sensor. The machine settings account for these temperatures to pump solder from the nozzle 11 at an expected flow rate.

In this example the camera 30 is used to obtain an image, or multiple images, of the soldering apparatus. From the image or images, any number of nozzle characteristics are determined. The nozzle characteristics include, but are not limited to, a geometric characteristic of the solder wave, such as the height of the solder wave or the shape of the solder wave; an actual calibration position of the nozzle 11 and/or solder pot 10 in the X, Y and Z directions; or a rotation of the solder pot 10 and/or nozzle 11. It will be appreciated that multiple cameras may be present, which view the nozzle 11 and/or solder pot 10 from different angles to determine the nozzle characteristics more accurately, or to determine a greater number of nozzle characteristics. Furthermore, when a wettable nozzle is used, the shape of the solder wave, as determined from the image or images obtained by the camera 30, may be used to identify oxidation at the nozzle 11. Oxidation might change the shape of the solder wave resulting in solder defects such as open solder joints or poor hole filling. Oxidation can also lead to clogging, for example dross clogging. Clogging causes the solder wave to change shape and is therefore detectable from changes in the solder wave shape.

Furthermore, by recording images over a time period, using the camera 30, the stability of the solder wave, from taking multiple measurements and thereby calculating variation, can be obtained. If the shape of the solder wave is not stable then this can be used to indicate that cleaning is required, or other maintenance actions are required, for example topping up of the solder level.

The camera 30, or one or more of multiple cameras, may be a thermal imaging camera. From a thermal image or thermal images obtained from the one or more thermal imaging camera, the temperature of the ejected solder is determined, the solder temperature providing another possible one of the nozzle characteristics.

The machine settings are adjusted to reduce a difference between the nozzle characteristics determined from the image or images, and an expected corresponding nozzle characteristic. In this example, determining of the nozzle characteristics and adjusting the machine settings is performed by the controller. The controller is configurable such that if the difference of any measured and expected nozzle characteristic is too high, then an alarm, message, or warning may be provided.

In this example the laser fork sensor 40 and/or the needle sensor 50 are located at discrete positions above the solder pot 10. In order for the controller to check the solder wave height using either of these sensors 40, 50, the solder pot 10 is moved to one of the sensors 40, 50 using the movement system 20 and instructed by the machine settings, such that when the solder is ejected from the nozzle 11, the solder is expected to be detected by the sensor 40, 50. If the ejected solder is not detected by the sensor 40, 50, then the controller determines that there are inaccuracies in the movement system 20. Otherwise, the controller may adjust the machine settings related to the solder height, if the expected ejected solder height and the measured ejected solder height, as measured by the sensor 40, 50, differ. The ejected solder height may be increased incrementally, as controlled by the controller, until the sensor 40, 50 detects the presence of the solder, for improved accuracy. Alternatively, the Y-direction position of the solder pot 10 may be increased incrementally, while maintaining the ejected solder height, until the sensor 40, 50 detects the presence of the solder, for improved accuracy. The sensors 40, 50 may be used to validate nozzle characteristics determined using the obtained image. Alternatively, or additionally, the sensors 40, 50 may be used alongside, or instead of the camera 30. It will be appreciated that any number of laser fork sensors 40 and/or needle sensors 50 may be provided in the soldering apparatus or in the soldering calibration apparatus.

Calibrating the operation of the soldering apparatus may be performed at any time, including before production, during production, or after production of electronics boards. Production may be paused at intervals for the calibration to be performed. Advantageously, performing calibration allows for errors due to movement of the movement system 20, for example due to heating of components, to be corrected for. Further advantageously, performing calibration allows for changes to the solder pot 10, nozzle 11 and/or ejected solder, for example due to heating, to be accounted for.

Any number of the machine settings, adjustments made thereto, the nozzle characteristics and measurements taken from any of the sensors, may be recorded by the controller as stored data. The stored data may then be analysed, by the controller, to determine trends in the data, or anomalous data entries, such that the controller may identify requirements for maintenance, identify faults, or predict a lifetime of certain parts of the soldering machine. The controller may also analyse the stored data to more accurately predict when consumables, such as solder wire, will need to be replaced, to identify faults with consumables, or to identify when an incorrect consumable has been used. By way of an example, reductions in ejected solder height and/or increases in coil temperature of the magnetic pump may indicate dross clogging, caused by oxidisation of solder in the nozzle 10.

Turning now to FIG. 2, there is shown the soldering pot 10 with a nozzle cleaning system 60 and an oxygen level sensor 70.

The nozzle cleaning system 60 may comprise an ultrasonic cleaner, a flux sprayer, solder wire which contains flux, such that the solder wire is held to the nozzle 11 to apply adipic acid powder to the nozzle 11, or any other suitable nozzle cleaning apparatus. Use of the nozzle cleaning system 60 may be initiated by the controller, upon detection of a requirement to clean the nozzle 11 from the solder wave shape obtained from the image or images. Use of the nozzle cleaning system 60 may also be initiated by the controller from stored data relating to the nozzle characteristics.

The oxygen level sensor 70 may be a Lambda sensor. The oxygen level sensor 70 is in communication with the controller. The oxygen level sensor 70 is usable to detect the oxygen level around the nozzle 11. An amount of nitrogen gas flow to the nozzle 11 can be increased or decreased to decrease or increase, respectively, the oxygen level at the nozzle 11. If changing the nitrogen flow to the nozzle 11 does not correct the oxygen level measured by the oxygen level sensor 70, then the controller may provide an alarm, or a warning.

Data relating to the nozzle cleaning system 60 and the oxygen level sensor 70 may also be stored by the controller in the stored data.

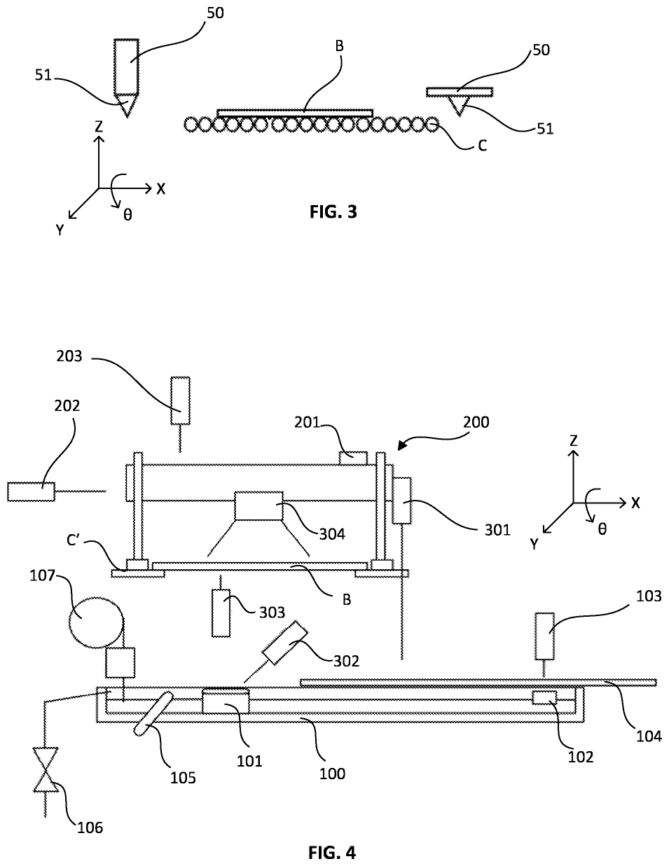

Turning now to FIG. 3, there is shown the conveyor C as described with reference to FIG. 1, with an electronics or calibration board B thereupon. In this example there are provided two needle sensors 50, each needle sensor 50 being as described with reference to FIG. 1.

The machine settings include a board target calibration position. In order to calibrate the operating of the soldering apparatus with a board B present, the board B is moved by the conveyor C according to the board target calibration position. The board target calibration position may be anywhere within the bounds of movement of the conveyor C. In this example the machine settings include a nozzle target calibration position and a board target calibration position which provide target relative positions of the nozzle 11 and board B such that the nozzle 11 is adjacent a soldering or calibration location on the board B. The conveyor C and/or the movement system 20 position the board B and the nozzle 11 respectively, according to the machine settings. From the image or images obtained using the camera 30, any number of board characteristics are determined. As explained with reference to FIG. 1, any number of cameras 30 may be present. The one or more board characteristics include, but are not limited to, an actual calibration position of the board; a location of each soldering or calibration location on the board; a distance between the at least one nozzle and the corresponding solder location on the board; and a temperature of the board.

In this example the controller analyses the board characteristics, and adjustments are made to the machine settings to reduce any differences between the board characteristics measured from the obtained image or images, and the expected board characteristics.

The controller may also determine, from the obtained image, an identity of the board B. This may be via markings, such as fiducial markings, on the board B. The controller may then load machine settings and/or expected board characteristics which are specific to the board B on the conveyor C.

The board characteristics may also be stored by the controller in the stored data. Analysis of the board characteristics may be used to identify faults, or a requirement for maintenance, of the conveyor C, or any issues with the boards B. The identity of the boards B may also be stored by the controller in the stored data. Any of the machine settings, board characteristics, nozzle characteristics or adjustments made may then be attributed to specific boards B. This may be used by a quality management system, to manage the quality of the boards B, for example to highlight any boards B which require inspection after soldering.

Turning now to FIG. 4 there is shown an example of soldering apparatus, which may be a part of soldering calibration apparatus, and which has a multi wave solder pot 100 used for soldering an electronics board. The multi wave solder pot 100 has at least one nozzle 101. Only one nozzle 101 is shown in FIG. 4, but, as will be appreciated, the number of nozzles 101 is determined by the number and layout of solder locations on the board B. A movement system (not shown) may be provided to adjust the position of the nozzle or nozzles.

In this example the solder pot 100 also has either or both of a float sensor 102 and/or a proximity sensor 103. The float sensor 102 and proximity sensor 103 are configured to measure a height of molten solder in the solder pot 100. The float sensor 102 and/or proximity sensor 103 are in communication with a controller.

In this example the soldering apparatus has a glass plate 104 which is configured to selectively cover the solder pot 100. The glass plate 104 moves aside to uncover at least one soldering nozzle 101.

In this example the soldering apparatus, or the soldering calibration apparatus, has an oxygen level sensor 105, for example a Lambda sensor, which is configured to measure oxygen levels inside of the solder pot 100. The oxygen level sensor is in communication with the controller.

In this example the soldering apparatus has a nitrogen valve 106 in a nitrogen gas supply line, which supplies nitrogen gas to the soldering pot. The nitrogen valve 106 is in communication with the controller.

In this example the soldering apparatus has a solder reel 107 which supplies solder to the solder pot 100. The solder reel 107 works in the same way as that described with reference to FIG. 1, with solder supply being controlled by the controller to maintain a required height of molten solder in the solder pot 100.

In this example a movement system 200 is used to control the movement of a conveyor C′, upon which the board B is moved. As in the previous example, the movement system 200 moves the conveyor C′ in an X-direction, Y-direction and a Z-direction, as shown by the arrows in FIG. 4. Also, as in the previous example, the movement system 200 may rotate the conveyor C′ in the e-direction, which is about the X-direction. Furthermore, the movement system 200 may rotate the movement system 200 about the Y and Z directions.

In this example, the movement system 200 has a vibration sensor 201 mounted thereto, which is in communication with the controller. The movement system 200 also has an X-direction position sensor 202 and a Z-direction position sensor 203. The position sensors 202, 203 are in communication with the controller. The movement system 200 may also have a Y-direction position sensor (not shown), which is in communication with the controller. The position sensors 202, 203 may be laser or proximity sensors.

In this example there is provided a camera 301 which is mounted to the movement system 200, and is configured to capture an image, or images, of the solder pot 100. There is provided another camera 302 which is configured to capture an image, or images, of the nozzle 101. It will be appreciated that the camera 302 may be configured to capture an image, or images, of all of the nozzles, or that multiple cameras may be present such that images of multiple nozzles are captured. The cameras 301, 302 are in communication with the controller.

In this example there is provided a thermal imaging camera 304. The thermal imaging camera 304 is mounted to the movement system 200 and is configured to capture an image of an upper surface of the board, the opposite surface to that which solder is applied to by the nozzle 101, in use. The thermal imaging camera 304 is in communication with the controller.

In this example there is provided a sensor 303 for identifying the board B. The sensor may be a scanner, or camera, for reading fiducial marks on the board B. The sensor 303 is in communication with the controller.

Calibration of the operation of the soldering apparatus may be performed with or without the board B present. In this example, when the board B is not present, a solder wave is pumped from each nozzle 101 according to machine settings provided by the controller. The machine settings include the temperature and height of the molten solder in the soldering pot 100, the feed rate of soldering wire from the solder reel 107 and the amount of nitrogen gas provided to the soldering pot. The machine settings also include a position of the glass pane 104 such that the glass pane 104 is positioned according to the machine settings. In this example the machine settings also include a nozzle target calibration position to position the solder pot 100 and/or nozzle 101 at a target relative position to the movement system 200. The machine settings may also include a movement system target calibration position. The movement system 200 and the solder pot 100 may be positioned according to the machine settings. Measurements from the float sensor 102 and/or the proximity sensor 103 are used by the controller to determine if the amount of solder being supplied to the solder pot 100 from the solder reel 107 should be changed, and machine settings defining the amount of solder wire provided to the soldering pot 100 are amended if required, to adjust the amount of solder wire provided by the solder reel 107. Measurements from the oxygen level sensor 105 are used by the controller to identify that an incorrect level of oxygen is present in the solder pot 100, in which case the controller will adjust machine settings relating to the nitrogen gas supply to the solder pot 100, and the nitrogen valve 106 will be adjusted according to the machine settings. The oxygen level may be incorrect due to, for example, moving of the glass plate 104 to uncover the nozzle 101.

The camera 302 obtains an image or images of the nozzle 101 to determine nozzle characteristics. The nozzle characteristics determined from the image or images include, but are not limited to, a geometric characteristic of the solder wave, such as the height of the solder wave, or the shape of the solder wave. The other camera 301 obtains an image or images of the solder pot 100. From the image or images of the solder pot nozzle characteristics are determined, which include, but are not limited to, an actual calibration position of the solder pot 100 and/or nozzle 101 in the X, Y and Z directions relative to the movement system 200, a rotation of the solder pot 100 and/or nozzle 101 relative to the movement system 200, and a position of the glass pane 104.

The controller compares the expected wave height with the actual wave height and adjusts the machine settings to correct for differences between the actual and measured wave heights.

The controller may also determine the shape of the solder wave from the obtained image. Machine settings may be adjusted if the measured shape of the solder wave is different to an expected value. Furthermore, a warning or alarm may be provided by the controller if the difference between the determined solder wave shape and the expected solder wave shape is beyond a prescribed threshold, as this could indicate a fault or clogging, for example due to oxidisation of solder.

The controller may also adjust machine settings to overcome any difference between the target and actual calibration positions, and any difference between expected and actual rotation, of the solder pot 100 and/or nozzle 101 and/or movement system 200. The controller may also adjust machine settings to overcome differences between the expected and measured position of the glass pane 104.

If calibration of the operation of the soldering apparatus is performed with a board B present, then, further to the aforementioned procedure, the machine settings define a board target calibration position. The board B is then moved, by the conveyor C′, according to the board target calibration position. The board B may be a calibration board or an electronics board. The movement system 200 also positions the board as per the board target calibration position, using feedback from the position sensors 202, 203. The thermal imaging camera 304 obtains a thermal image or thermal images of the upper surface of the board B. If solder is applied to the board B, for example if an electronics board is used, then the thermal image or images may be obtained before, during, and after the application of solder to the board B. From the thermal images, board characteristics are determined, which include the temperature of the board before, during, and/or after solder is applied.

There may also be provided another or other camera/s (not shown) which are configured to capture an image, or images, of the board B and of the solder pot 100, simultaneously. This image or these images may be used to determine further board characteristics, such as, but not limited to, any number of: the actual calibration position of the board B, a location of each soldering or calibration location on the board B, or a distance between the nozzle 101 and the corresponding solder or calibration location on the board B.

Machine settings are then adjusted to overcome differences between the expected board characteristics the measured board characteristics.

The sensor 303 is used to identify the board B. This could be to identify a type of board, for example an electronics board or a calibration board, of to identify the specific board B which is present. The reading from the sensor 303 is use by the controller to determine appropriate machine settings for the board.

As in the previous example, the controller may store machine settings, nozzle characteristics, board characteristics, adjustments made to machine settings and/or any sensor readings, in a data log.

Analysis of the data log may be performed to identify faults, or a requirement for maintenance, as described in the previous examples. The identity of the boards B may also be stored by the controller in the stored data. Any of the machine settings, board characteristics, nozzle characteristics, adjustments made, and/or any sensor measurements may then be attributed to specific boards B. This may be used by a quality management system, to manage the quality of the boards B, for example to highlight any boards B which require inspection after soldering.

In any of the aforementioned examples, air or nitrogen may be blown into the solder pot 10, 100 to determine the molten solder level in the solder pot 10, 100. The molten solder height is determined by the controller using a correlation of the pressure required to form a bubble of air or nitrogen in the molten solder, and the molten solder level.

Also, in any of the aforementioned examples, the reel of solder wire may contain a barcode or other identification, which is captured by the camera, or another sensor, such as a scanner. This provides the controller with information about the solder wire, which may provide parameters for the machine settings, for example melting temperature or parameters which are used to calculate maintenance intervals.

Also, in any of the aforementioned examples, wave height may be measured using eddy current sensors, as well as, or instead of, using the image obtained using the camera or cameras.

Also, in any of the aforementioned examples, the nozzle/s may be removed, and new nozzle/s installed, based upon analysis of the stored data. The nozzle/s may be removed and replaced automatically.

The following numbered clauses are provided:

Clause 1. A method of calibrating the operation of soldering apparatus in a soldering machine, the soldering apparatus comprising at least one nozzle which is configured to apply solder to an electronics board, in use, the method comprising:
providing machine settings to the soldering machine, the machine settings including a nozzle target calibration position and at least one solder setting for the at least one nozzle:
positioning the at least one nozzle according to the nozzle target calibration position; and
pumping solder from the at least one nozzle according to the at least one solder setting, when the at least one nozzle is positioned according to the target calibration position;
obtaining at least one image of the soldering apparatus;
determining, from the at least one image, at least one nozzle characteristic;
adjusting the machine settings to reduce a difference between the at least one nozzle characteristic determined from the at least one image, and a corresponding expected at least one nozzle characteristic.

Clause 2. A method according to clause 1, wherein the at least one nozzle characteristic comprises one of:
an actual calibration position, for example in three dimensional Cartesian coordinates, and/or an orientation, of the at least one nozzle;
at least one geometric characteristic of the solder flowing from the at least one nozzle, the at least one geometric characteristic comprising, for example, a height, or a shape, of the flow of solder from the at least one nozzle;
a temperature of the solder flowing from the at least one nozzle.

Clause 3. A method according to clause 1 or clause 2, wherein the machine settings further comprise a board target calibration position, wherein the soldering apparatus further comprises a conveyor which positions the board according to the board target calibration position, in use, and wherein the at least one nozzle characteristic comprises a distance between the at least one nozzle and the conveyor.

Clause 4. A method according to any preceding clause, wherein the machine settings further comprise a board target calibration position, wherein the soldering apparatus further comprises a conveyor which positions the board according to the board target calibration position, in use, and wherein the method further comprises:
positioning the board using the conveyor according to the board target calibration position, wherein the board target calibration position is expected to position the board relative to the at least one nozzle such that the at least one nozzle is adjacent a soldering or calibration location on the board;
determining at least one board characteristic from the at least one image; and
adjusting the machine settings to reduce a difference between the at least one board characteristic determined from the at least one image, and a corresponding expected at least one board characteristic.

Clause 5. A method according to clause 4, wherein the at least one board characteristic comprises one of:
an actual calibration position of the board, for example in three dimensional Cartesian coordinates;
a location of each soldering or calibration location on the board;
a distance between the at least one nozzle and the corresponding solder or calibration location on the board;
a temperature of the board.

Clause 6. A method according to either of clause 4 or clause 5, wherein an identity of the board is determined from the image, for example using fiducial marks on the board.

Clause 7. A method according to any preceding clause, wherein the at least one image is obtained using at least one camera, for example a thermal imaging camera.

Clause 8. A method according to any preceding clause, further comprising measuring oxygen levels around the at least one nozzle and adjusting a nitrogen supply to the at least one nozzle to adjust the oxygen level.

Clause 9. A method of maintaining a soldering machine, the method comprising recording and analysing any number of the machine settings, nozzle characteristics, board characteristics and adjustments to the machine settings made in any preceding clause, to identify requirements for repair, maintenance, or replacement of parts of the soldering machine.

1-16. (canceled)

17. A method of calibrating the operation of soldering apparatus for use in a soldering machine, the soldering apparatus comprising at least one nozzle which is configured to apply solder to an electronics board, in use, the method comprising:
providing machine settings to the soldering apparatus, the machine settings including a nozzle target calibration position and at least one solder setting for the at least one nozzle:
positioning the at least one nozzle according to the nozzle target calibration position;
pumping solder from the at least one nozzle according to the at least one solder setting, when the at least one nozzle is positioned according to the target calibration position;
obtaining at least one image of the soldering apparatus when the at least one nozzle is positioned according to the nozzle target calibration position;
determining, from the at least one image, at least one nozzle characteristic; and
adjusting the machine settings to reduce a difference between the at least one nozzle characteristic determined from the at least one image, and a corresponding expected at least one nozzle characteristic.

18. The method according to claim 17, wherein the at least one nozzle characteristic comprises at least one of an actual calibration position of the at least one nozzle or an orientation of the at least one nozzle.

19. The method according to claim 17, wherein the at least one image of the soldering apparatus is obtained while pumping solder from the at least one nozzle.

20. The method according to claim 19, wherein the at least one nozzle characteristic comprises at least one of a geometric characteristic of the solder flowing from the at least one nozzle or a temperature of the solder flowing from the at least one nozzle.

21. The method according to claim 20, wherein the geometric characteristic comprises at least one of a height or a shape of the flow of solder from the at least one nozzle.

22. The method according to claim 17, wherein the machine settings further comprise a board target calibration position, wherein the soldering apparatus further comprises a conveyor which positions the board according to the board target calibration position, in use, and wherein the at least one nozzle characteristic comprises a distance between the at least one nozzle and the conveyor.

23. The method according to claim 17, wherein the machine settings further comprise a board target calibration position, wherein the soldering apparatus further comprises a conveyor which positions the board according to the board target calibration position, in use, and wherein the method further comprises:
positioning the board using the conveyor according to the board target calibration position, wherein the board target calibration position is expected to position the board relative to the at least one nozzle such that the at least one nozzle is adjacent a soldering or calibration location on the board;
determining at least one board characteristic from the at least one image; and
adjusting the machine settings to reduce a difference between the at least one board characteristic determined from the at least one image, and a corresponding expected at least one board characteristic.

24. The method according to claim 23, wherein the at least one board characteristic comprises at least one of:
an actual calibration position of the board;
a location of each soldering or calibration location on the board;
a distance between the at least one nozzle and the corresponding solder or calibration location on the board; or
a temperature of the board.

25. The method according to claim 23, wherein an identity of the board is determined from the image.

26. The method according to claim 17, wherein the at least one image is obtained using at least one camera.

27. The method according to claim 17, further comprising measuring oxygen level around the at least one nozzle and adjusting a nitrogen supply to the at least one nozzle to adjust the oxygen level.

28. A method of maintaining a soldering machine, the method comprising recording and analysing at least one of machine settings of the soldering machine, nozzle characteristics, board characteristics, or adjustments to the machine settings made claim 16, to identify requirements for repair, maintenance, or replacement of parts of the soldering machine.

29. A soldering calibration apparatus comprising:
a soldering apparatus for use in a soldering machine, the soldering apparatus comprising at least one adjustable nozzle which is configured to apply solder to an electronics board, in use, and at least one pump configured to pump solder from the at least one adjustable nozzle;
at least one camera configured to obtain at least one image of the soldering apparatus;
a controller configured to:
provide machine settings to the soldering apparatus, the machine settings including a nozzle target calibration position and at least one solder setting for the at least one nozzle:
position the at least one nozzle according to the nozzle target calibration position;
pump solder from the at least one nozzle according to the at least one solder setting, when the at least one nozzle is positioned according to the target calibration position;
obtain, using the at least one camera, at least one image of the soldering apparatus when the at least one nozzle is positioned according to the nozzle target calibration position;
determine, from the at least one image, at least one nozzle characteristic; and
adjust the machine settings to reduce a difference between the at least one nozzle characteristic determined from the at least one image, and a corresponding expected at least one nozzle characteristic.

30. The soldering calibration apparatus according to claim 29, wherein the soldering apparatus further comprises a conveyor which positions the board according to the board target calibration position, in use, wherein the machine settings further comprise a board target calibration position, and wherein the at least one nozzle characteristic comprises a distance between the at least one nozzle and the conveyor.

31. The soldering calibration apparatus according to claim 29, wherein the at least one camera comprises a thermal imaging camera.

32. The soldering calibration apparatus according to claim 29, further comprising an oxygen sensor configured to measure an oxygen level around the at least one nozzle, wherein the controller is further configured to adjust a nitrogen supply to the at least one nozzle to adjust the oxygen level.

33. A soldering machine comprising the soldering calibration apparatus of claim 29.
